(19) United States
(12) Patent Application Publication
(10) Pub. No.: US 2009/0103761 A1
(43) Pub. Date: Apr. 23, 2009

(54) REMOVABLE MICROPHONE

(76) Inventor: JEN-HUAI FAN, Taipei City (TW)

Correspondence Address: SCHMEISER, OLSEN & WATTS, 22 CENTURY HILL DRIVE, SUITE 302, LATHAM, NY, 12110, US

(21) Appl. No.: 11/873,591

(22) Filed: Oct. 17, 2007

(51) Int. Cl. H04R 25/00

(52) U.S. Cl. 381/375

(57) ABSTRACT

A removable microphone includes an engaging member for engaging with an ear cup of a headphone; a first signal transmission interface provided on the engaging member for electrically connecting to a second signal transmission interface provided on the ear cup of the headphone; a signal transmission unit provided on the engaging member; and a voice receiver provided on the engaging member. When a user wearing the headphone wants to communicate with another user online in real time, he needs only to attach and accordingly electrically connect the engaging member of the removable microphone to the ear cup of the headphone. Therefore, a user may flexibly select to use the headphone with or without a microphone.

### FIELD OF THE INVENTION

The present invention relates to a removable microphone, and more particularly to a microphone that can be removably engaged with a corresponding ear cup of a headphone.

### BACKGROUND OF THE INVENTION

With the quickly developed networks, video games allowing a plurality of players to play online at the same time have gradually replaced the conventional console game. In response to the online video games, real-time voice communication has also been developed. A microphone is required for online video game players to communicate with one another while playing the video game online. One of the conventional microphones for use in online communication is externally connected to a game platform. When a player talks, his voice is transmitted via the microphone. However, in such a manner, the microphone is quite distant from the player and the transmitted voice might very possibly be interfered by ambient noises. Another conventional microphone for use in online communication is integrated with a headphone. In this case, the voice reply from another online player is frequently combined with the rumble sound of the video game and could not be clearly heard. On the other hand, in the case the video game player is not playing the online games, the microphone integrated with the headphone seems to be useless and unnecessary.

It is therefore tried by the inventor to develop a microphone that can be removably mounted and electrically connected to an ear cup of a headphone by an online game player when the player wants to communicate with another online player in real time. Therefore, a player is given the flexibility in using the headphone with or without a microphone.

### SUMMARY OF THE INVENTION

A primary object of the present invention is to provide a microphone that can be removably attached and electrically connected to a corresponding ear cup of a headphone for a user wearing the headphone to communicate with another online user in real time when necessary.

To achieve the above and other objects, the removable microphone according to the present invention includes an engaging member for engaging with an ear cup of a headphone; a first signal transmission interface provided on the engaging member for electrically connecting to a second signal transmission interface provided on the ear cup of the headphone; a signal transmission unit provided on the engaging member; and a voice receiver provided on the engaging member.

When a user wearing the headphone wants to communicate with another user online, he needs only to attach and accordingly electrically connect the engaging member of the removable microphone to the ear cup of the headphone to obtain a real-time communication effect. Therefore, the removable microphone gives a user the flexibility in using a headphone with or without a microphone.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a removable microphone according to an embodiment of the present invention;

FIG. 2 shows an example of application of the removable microphone of the present invention in online gaming; and

FIG. 3 shows a preferred embodiment of arranging sound-reproducing units on a headphone corresponding to the removable microphone of the present invention.

### DETAILED DESCRIPTION OF THE PREFERRED EMBODIMENTS

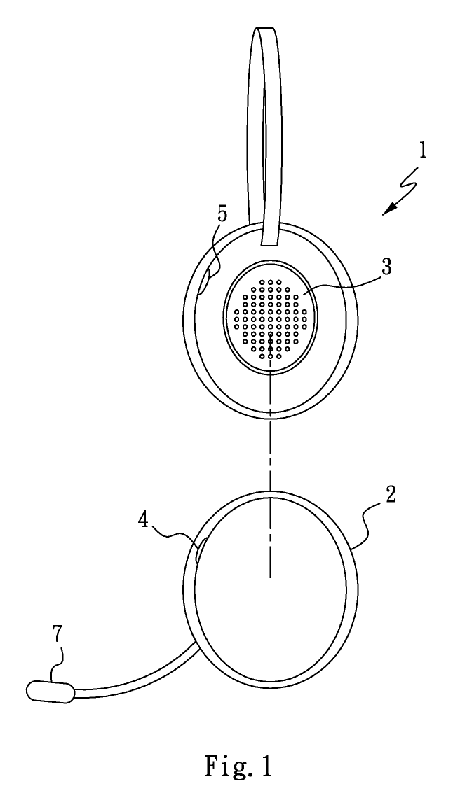

Please refer to FIG. 1 that is an exploded perspective view of a removable microphone 1 according to an embodiment of the present invention. As shown, the removable microphone 1 includes an engaging member 2 for engaging with an ear cup 3 of a headphone; a first signal transmission interface 4 provided on the engaging member 2 for electrically connecting to a second signal transmission interface 5 provided on the ear cup 3 when the engaging member 2 is engaged with the ear cup 3; a first signal transmission unit 6, which may include, but not limited to, a wired signal transmission unit and a wireless signal transmission unit; and a voice receiver 7 connected to the engaging member 2.

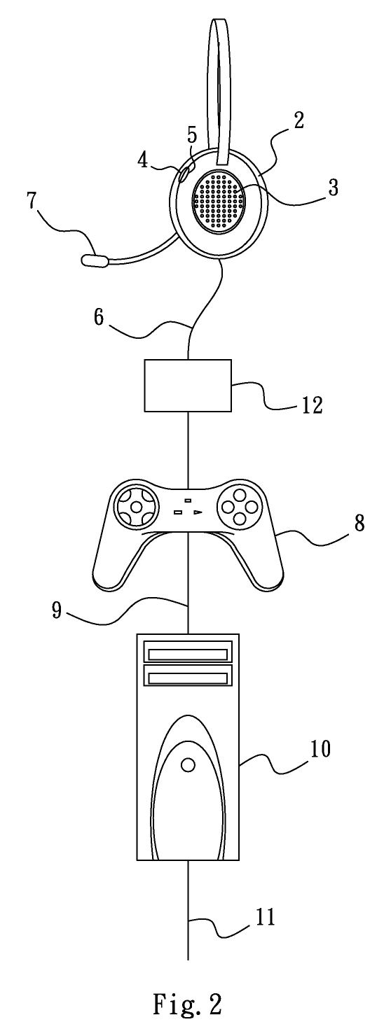

FIG. 2 shows an example of application of the removable microphone of the present invention in online gaming. Please refer to FIGS. 1 and 2 at the same time. When a first online game player wants to communicate with a second online game player in real time, the first player may engage the removable microphone 1 with the ear cup 3, so that the first signal transmission interface 4 on the engaging member 2 is electrically connected to the second signal transmission interface 5 on the ear cup 3. At this point, the first player's voice may be transmitted from the voice receiver 7 to a joystick 8 via the first signal transmission unit 6. The joystick 8 is provided with a second signal transmission unit 9, which may be a wired or a wireless signal transmission unit. The first player's voice transmitted to the joystick 8 is sent via the second signal transmission unit 9 to an operating platform 10, which further transmits the first player's voice via a network 11 to the second player. In the case the second player replies, his voice is transmitted via the network 11 to the operating platform 10, and from the operating platform 10 to the joystick 8 via the second signal transmission unit 9, and then from the joystick 8 via the first signal transmission unit 6 to the first signal transmission interface 4 and the second signal transmission interface 5. Finally, the second player's voice sent to the second signal transmission interface 5 is reproduced from at least one sound-reproducing unit provided on the ear cup 3. According to actual need, the removable microphone 1 of the present invention may be further provided with a volume control unit 12 for regulating the sound volume thereof.

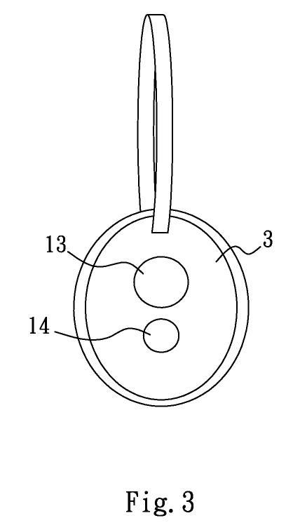

Please refer to FIG. 3 that shows a preferred embodiment of arranging sound-reproducing units on the ear cup 3 corresponding to the removable microphone of the present invention. To avoid the second online game player's voice reply and the rumble sound of the online game from being reproduced via the same one sound-reproducing unit and adversely mixed to confuse the first player, the ear cup 3 is preferably provided with two separate sound reproducing units, namely, a game sound effect reproducing unit 13 and a voice reproducing unit 14. Therefore, the voice reply and the rumble sound of video game may be independently played via the headphone and clearly distinguished without causing confusion to a user.

As mentioned above, a user wearing a headphone in playing an online game may communicate with another online game player in real time simply by mounting the removable microphone of the present invention to the ear cup of the headphone to electrically connect the first and the second signal transmission interface 4, 5 to each other. Therefore, the removable microphone of present invention gives a user the flexibility in using a headphone with or without a microphone, and is industrially valuable to meet the current market demands.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A removable microphone, comprising:
an engaging member for engaging with an ear cup of a headphone;
a first signal transmission interface provided on the engaging member for electrically connecting to a second signal transmission interface provided on the ear cup of the headphone;
a signal transmission unit provided on the engaging member; and
a voice receiver provided on the engaging member.

2. The removable microphone as claimed in claim 1, wherein the ear cup of the headphone is provided with at least one sound-reproducing unit.

3. The removable microphone as claimed in claim 1, wherein the ear cup of the headphone is provided with a sound effect reproducing unit and a voice reproducing unit.

4. The removable microphone as claimed in claim 1, wherein the signal transmission unit is selected from the group consisting of a wired signal transmission unit and a wireless signal transmission unit.
